(19) United States
(12) Patent Application Publication
(10) Pub. No.: US 2006/0269634 A1
(43) Pub. Date: Nov. 30, 2006

(54) Mould and overmould assembly with anti-lift action

(75) Inventor: Stephane Westeel, Bondues (FR)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(73) Assignee: APLIX

(21) Appl. No.: 11/436,305

(22) Filed: May 18, 2006

(30) Foreign Application Priority Data
May 27, 2005 (FR) 05 05373

(51) Int. Cl. B29C 44/58

(52) U.S. Cl. 425/4 R

(57) ABSTRACT

An assembly includes an overmould intended to be fixed to a foam object, the overmould having a base with a central section. Hooks project from the first side and form male parts of a self-gripping member. Two sections forming selvages are on either side of the central section. the assembly can include a mould destined to form through moulding the moulded object to which the overmould is intended to be fixed, the mould having a cavity delimited by walls. The overmould is arranged on the cavity, having at least a section of its selvages in contact with the upper surfaces of the walls of the cavity and the hooks inside the cavity. A material which can be attracted by a magnet is fixed to the overmould, and a magnet is in the bottom of the cavity to attract the overmould. The selvages each include a first contact section located above the walls of the hook protection cavity of the mould, and a second end section which projects beyond the walls, on the outer lateral side of the cavity. These end sections are perforated, preferably such that the ratio of the area of the perforated sections and the total area of the end sections is greater than 50%.

### TECHNICAL FIELD

The present invention relates to an assembly comprising on the one hand an overmould which is intended to be fixed to an object moulded in a foam, the overmould comprising a base having a central section, from a first side of which hooks project which form male parts of a self-gripping member, and two sections forming selvages on either side laterally of the central section, and on the other hand a mould intended to form through moulding the moulded object to which the overmould is intended to be fixed, the mould comprising for example at the bottom a cavity delimited by walls, the overmould being arranged on the cavity having at least a section of its selvages in contact with the upper edges of the walls of the cavity and the hooks inside the cavity, a material which can be attracted by a magnet being fixed to the overmould while a magnet is arranged at the bottom of the cavity in order to attract the overmould.

The selvages are thus pressed against the upper edges of the walls in order to thus ensure sealtightness and to allow foam to be transferred in order to form the moulded object without it infiltrating into the cavity and coming into contact with the hooks, causing them to lose their fastening character.

The present invention also relates to an overmould intended to be used in an assembly according to the invention and a unit comprising a moulded foam object to which an overmould is fixed according to the invention.

### BACKGROUND ART

An assembly of this type is already known, particularly from the French patent application No. 0213217 filed on 23 Oct. 2002 in the name of the applicant. The assemblies of the prior art of this type have the following drawback. As the selvages are placed flat on the upper surfaces of the walls delimiting the hook protection cavity without extending outside of the cavity beyond these walls, when the foam is transferred or cast it comes into contact with these selvages solely by means of the upper side (the opposite side to that on which the hooks are formed) and the moulded object is not properly fixed to the overmould because the foam is only in contact with the overmould on the upper side of this. It would be desirable for the foam to be in contact with the selvage on at least a section of the lower side also. However, in order to do this, it would be necessary, when the overmould is placed on the upper surfaces of the walls of the hook protection cavity, to bring the selvages beyond the walls on the outer side of the cavity. If the selvages are extended in this way, when the foam is poured it moves firstly to the bottom of the mould, below the overmould and in particular below the selvages, rising until it reaches the level of the upper surfaces of the walls, then passes beyond this level to fill the whole mould. The foam initially cast which is in the bottom of the mould begins to take as a whole whereas more liquid foam is still transferred into the mould. This foam at the bottom becomes more paste-like and tends to rise. Coming from the bottom of the overmould it pushes the latter upwards by means of the section of the selvage which projects beyond the walls. This brings about a deterioration of the sealtightness at the interface between the selvages and the upper surfaces of the walls of the hook protection, cavity, and the more liquid foam which is being transferred then tends to infiltrate more easily into the cavity and to contaminate the hooks. Consequently it is not possible at the present time to extend the selvages in order to ensure better anchoring of the overmould to the moulded object.

JP 2003-019006 likewise discloses an assembly in which the selvages do not rest flat on the upper surface of the walls of the mould, but solely being inclined in contact with the inner edge, wherein the inclination is favoured by grooves of a smaller thickness formed in the overmould. Holes are formed in the selvages in order to facilitate anchoring of the overmould in the foam after hardening. These holes are mentioned in the description of the Japanese application as being small.

### DISCLOSURE OF THE INVENTION

It is an object of the present invention to overcome the drawbacks of the prior art by proposing an assembly which will allow the foam to be in contact with at least a section of the lower side of the selvages of the overmould in the final product, thus obtaining a product in which the overmould is better fixed to the moulded object, and indeed without deterioration of the sealtightness at the interface between the selvages and upper edges of the walls of the hook protection cavity and consequently without foam having been able to infiltrate into the cavity and contaminate the hooks, wherein the hooks retain the same fastening qualities in relation to loops of a self-gripping member as in the case of the overmoulds of the prior art.

According to the invention the assembly is as defined in claim 7 or 8.

By thus providing selvages with end sections perforated with large holes, it is possible for the overmould to extend beyond the walls and when the rising foam reaches the overmould from the bottom of the mould it passes across this without pushing it upwards. Thus, the upward pushing force in relation to the overmould by the foam which rises from the bottom of the mould is cancelled out by the existence of the holes and the overmould is still kept well pressed against the upper surfaces of the walls of the hook protection cavity by the attracting force of the magnet on the magnetic material of the overmould, and foam cannot infiltrate into the cavity. In the end the moulded object obtained is better fixed to the overmould and in particular is in contact with the overmould through its two upper and lower sides at least in part without the hooks having lost their fastening capacity in relation to moulded objects of the prior art, that is to say without foam coming into contact with the hooks. To date, with the prior art, it was not provided that selvages could be placed flat on the upper surfaces of the vertical walls of the mould; ^{M}large” holes were not provided either.

According to a preferred embodiment the lateral end border of the end sections is rectilinear or has a slight curve.

Thus, in spite of the presence of the holes, the overmould is well supported on the walls in a very compact way without undergoing torsional deformation through the effect of the foam.

According to a preferred embodiment all the empty sections are surrounded by full sections of the end section.

In spite of the presence of holes, the overmould is supported in an even better way on the walls without undergoing torsional deformation through the effect of the foam.

The present invention also relates to an overmould as defined in one of the claims 1 to 6.

The present invention also relates to a moulded foam object to which an overmould according to the invention is fixed, characterized in that the foam is in contact with the overmould by means of at least a section of its lower side and at least a section of its upper side.

### BRIEF DESCRIPTION OF THE DRAWINGS

An embodiment of the invention is shown in the drawings merely by way of example.

FIG. 1 is a cross-section of an assembly according to the invention, an overmould according to the invention being placed on the walls of the hook protection cavity arranged at the bottom of the mould of the assembly,

FIG. 2 a plan view of a moulded object obtained after solidification of the foam, and

FIG. 3 a top view of the overmould of the assembly of FIG. 1.

The drawings are not to scale, particular as regards the dimensions relating to the different sections of the selvages and of the central section.

### PREFERRED EMBODIMENT FOR CARRYING OUT THE INVENTION

In the drawings the overmould comprises a base 2 which is substantially planar. Hooks 3 project from a lower side 4 of the base wherein they are arranged in a strip of hooks, thus defining a central section 5 of the base. Two regions 6 and 7 forming selvages without hooks extend from each side of the central section 5. These two selvages 6 and 7 rest on the upper surfaces 12 and 13 of vertical walls 10 and 11, delimiting a cavity 9 intended to protect the hooks when the foam is poured into a mould, of which the bottom is designated by the reference numeral 14. The upper surfaces 12 and 13 are at a distance from the bottom of the mould and in particular at a greater height. A metallic resin 15 in the form of a rib is fixed, particularly by adhesion or mere solidification of the resin, on the upper side 8 opposite to the lower side 4 of the base. The hooks are arranged in rows, three rows being shown in the drawing. In general the base 2 has a length (in the perpendicular direction in the drawing) which is much greater than its width. In the same way the rows of hooks are arranged in a strip of which the length is greater than the width.

The selvages 6 and 7 each comprise a section 26, 27 in contact with the respective surfaces 12 and 13, namely the two sections of the selvages which are intended to be located above the surfaces 12 and 13, being pressed against them through the effect of the magnetic attraction of the metallic resin by means of a magnet 30 arranged at the bottom of the cavity 9. The selvages 6 and 7 also comprise end sections 36 and 37 which project beyond the walls 10 and 11 of the cavity 9, on the outer side of the cavity 9. Circular holes (but which could also be in other shapes, for example square, oval, rectangular, etc.) are formed in the end sections 36 and 37. These holes 40 have a total area which corresponds to more than half of the total area of the end sections 36, 37 of the selvages. All these opening holes 40 are totally surrounded by material of the base 2. The lateral end edges 50, 51 of the end sections 36, 37 of the selvages are straight lines or slightly circular lines without indentation.

When the foam is poured into the mould, this begins by filling the bottom of the mould, then rises towards the top of the mould. When it reaches the level of the overmould it does not tend to push this overmould upwards by pushing against the lower sides of the end sections of the selvages because it passes across the holes 40. Thus, the overmould does not tend to become detached from the upper surfaces 12, 13 of the walls 10 and 11 of the cavity 9 and the sealtightness of the interface between the selvages and the upper surfaces of the walls is not interrupted, is properly maintained and the foam does not infiltrate into the cavity and “contaminate” the hooks. Once the mould is completely full and the foam has solidified the unit formed by the solidified foam and the overmould can be removed. A moulded foam object is thus obtained which comprises an overmould of which the hooks have retained their full capacity for fastening to loops in order to form male parts of a self-gripping member, for example for fixing a fabric by means of loops, for example in the case of a motor car cushion. At the same time the overmould is properly fixed to the foam or to the cushion because the foam of the cushion covers at least in part the sections of selvages on their two upper and lower sides. The material used for the base 2 is preferably polyamide 6, 11 or 12 (12 being preferred) or polyamide 6-6. Polyethylene, polypropylene or any other thermoplastic or thermo-setting material can also be used, particularly polyester.

The foam cast is a material which is compatible with that of the overmould, that is to say it fixes well when it solidifies in contact with the overmould. In particular polyether or polyurethane foam can be chosen. Other materials are of course possible. The two lateral walls of the mould are at a distance from each other, wherein the distance can be less than 12 mm, preferably less than 10 mm, for example equal to 6 mm. The total width of the strip of hooks can be between 3 and 10 mm, or even more. The width of each selvage is between 2 and 30 ram. In particular the width of the end section of each selvage is between 1 mm and 15 mm. The ratio of the lateral extension of the end section and the lateral extension of the contact section can be between 0.1 and 15, preferably between 2 and 8.

The hooks are in the shape of a fir tree which includes a trunk with a rectangular section, particularly square, projecting from the base and ending in a head formed by the top which has two inclined surfaces joining at the point and of which the base is larger than the cross-section of the trunk, in such a way as to form two reinforcements on either side of the trunk. At approximately mid-height there two wings projecting from the trunk in the form of downwardly curved hooks. These hooks are realized through extrusion. Other forms of hooks are also possible.

The metallic resin can comprise 6 g metallic powder, for example 8.4 g per linear metre, mixed with a conventional resin of at least 4 g per linear metre, for a total weight of metallic resin of at least 10 g per linear metre.

For an end section, the total area is defined as being the area of the selvage from the line 60 (in dotted lines in FIG. 3) or delimitation curve in the plan of the selvage, in which there are, to the side of this line which is outside of the hooks, gaps or holes in the selvage as far as the line or end delimitation curve (the lateral border 50, 51) of the selvage, while on the other side of the delimitation curve or line the selvage is full, and the area of the holes being the area of the empty sections or holes within the total area.

According to a preferred embodiment the selvages can each comprise at least two ribs, preferably at least three or four ribs, which project from the selvages from the same side of the base as the hooks.

When the overmould is placed on the upper surfaces of the delimitation walls of a hook protection cavity at the bottom of the mould intended to form the moulded object to which the overmould is to be fixed, decompression chambers are formed, with these ribs, delimited by the selvages, the ribs and the upper surfaces of the delimitation walls of the cavity. These compression chambers allow the sealtightness of the interface between the selvages and upper edges to be increased, and this being with the same magnetization force. In fact, on the one hand, by means of a point effect, the magnetization force is now distributed in points or lines (along the tops of the ribs) instead of over the surface, these points or lines thus having a greater application force than a pressure over the surface with the same magnetization. On the other hand when the foam is cast low pressure air pockets are formed in the decompression chambers which have a sort of sucker effect which maintains the overmould against the upper surfaces of the walls in an even better way. Besides, when one of the ribs loses contact through the effect of the pressure of the foam and the latter penetrates into a first chamber, the outermost one in relation to the hooks, a sort of decompression or expansion of the foam is produced, tending to stop the progression towards the following chamber.

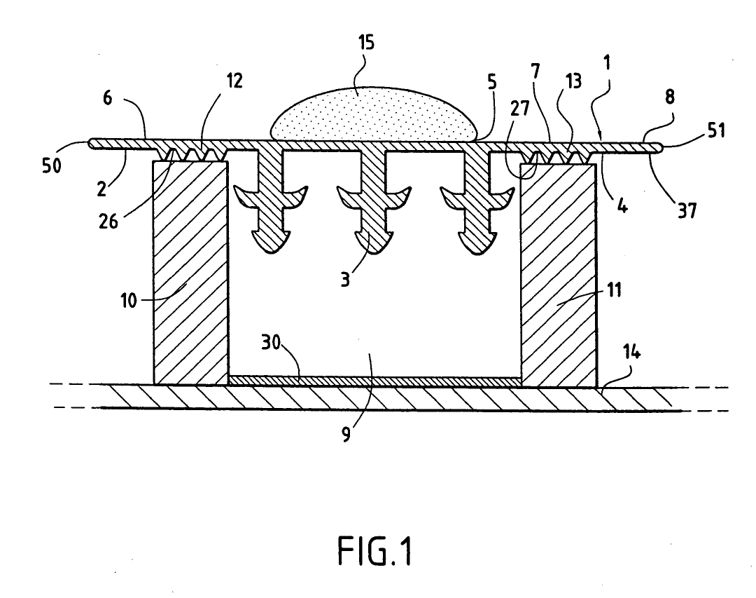

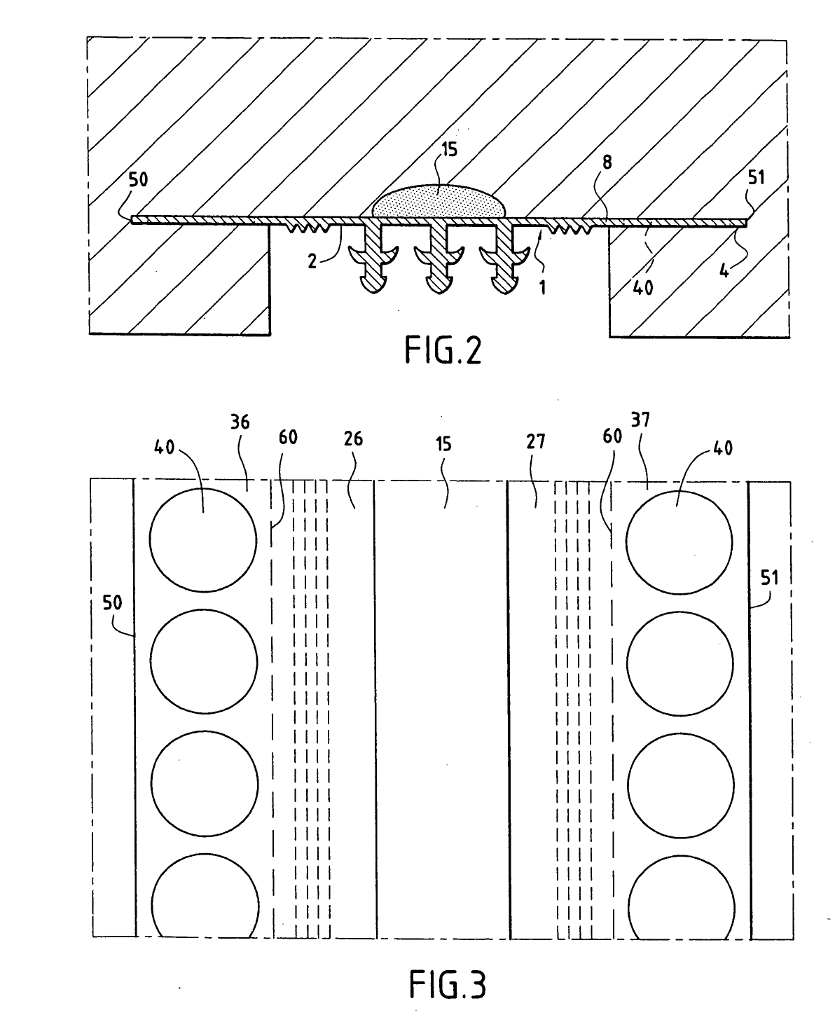

The longitudinal ribs 40, 41, 42 which are parallel to each other (that is to say extending along the perpendicular in FIG. 1) project respectively from the selvages 6 and 7 on the same side of the base 2 as the hooks. Between these three ribs 40, 41, 42 two grooves 50, 51 are formed. The ribs have a height calculated perpendicularly to the selvages 6 or 7 between 0.2 mm and 4 mm. In particular these ribs have a height which is lower than that of the hooks, in particular lower than at least half of that of the hooks, preferably lower than at least a quarter of that of the hooks. The ribs 40, 41, 42 have a triangular cross-section, the point facing downwards. The selvages extend laterally on the side of the ribs which is remote from the hooks over a distance between 1 and 15 mm. In particular this distance can be greater than the distance between the hooks and the ribs. The ribs are separated from each other by a planar section of the selvage, this planar section extending over a distance which can be between 0.3 mm and 2 mm for example.

The width measurement of the perforated end section (between the line 60 and the line 50 or 51) is between 1 and 20 mm, particularly between 6 and 8 mm. The width measurement of the contact section (between the line 60 and the edge of the central region with hooks) is between 1 and 20 mm, particularly between 2 and 6 mm. In particular the upper surfaces of the walls have a width greater than 2 mm, preferably greater than or equal to 3 mm, in order to ensure good sealtightness. Thus, the perforated end section preferably has a width which is greater than that of the contact section.

The selvages 6, 7 each comprise at least two ribs, preferably at least three or four ribs, which project from the selvages on the same side of the base as the hooks, the selvages being in contact with the upper edges of the walls by means of these ribs.

What is claimed is:

1. An overmould comprising a base having a central section, from a first side of which hooks project, and two sections forming selvages laterally from each side of the base, each selvage (6, 7) having an intermediate contact section which is substantially complete and a perforated end section (36, 37), characterized in that the ratio of the area of the perforations (40) of the end section and the total area of the end section is greater than 33%.

2. The overmould of claim 1, characterized in that the ratio of the area of the perforated sections (40) and the total area of the end sections is greater than 50%, more preferably greater than 60%.

3. The overmould of claim 1, characterized in that the lateral end border (50, 51) of the end sections is rectilinear or slightly curved.

4. The overmould of claim 1, characterized in that all the perforated sections (40) are surrounded by complete sections of the end section.

5. The overmould of 1, characterized in that the end sections have a lateral extension which is greater than that of the contact sections.

6. An assembly comprising on the one hand an overmould (1) intended to be fixed to an object moulded in a foam, the overmould comprising a base (2) having a central section, from a first side of which hooks project which form male parts of a self-gripping member, and two sections forming selvages (6, 7) on either side laterally of the central section, and on the other hand a mould destined to form through moulding the moulded object to which the overmould is intended to be fixed, the mould comprising at the bottom (14) a cavity delimited by walls (10, 11), the overmould being arranged on the cavity, having at least a section of its selvages (6, 7) in contact with the upper surfaces of the walls of the cavity and the hooks inside the cavity, a material (15) which can be attracted by a magnet being fixed to the overmould, while a magnet (30) is arranged at the bottom of the cavity in order to attract the overmould, characterized in that the selvages (6, 7) each comprise a first contact section (26, 27), of which at least a part is intended to be located on the upper surfaces of the walls of the hook protection cavity of the mould of the assembly, and a second end section (36, 37) which projects beyond the walls, on the outer lateral side of the cavity, and these end sections are perforated, particularly to the extent that the ratio of the area of the perforated sections (40) and the total area of the end sections is greater than 33%, preferably greater than 50%, more preferably greater than 60%.

7. The assembly of claim 6, characterized in that the upper surfaces of the walls have a width measurement which is greater than 2 mm, preferably greater than or equal to 3 mm.

8. A moulded foam object to which an overmould according to claim 6 is fixed, characterized in that the foam is in contact with the overmould by means of at least a section of the lower side (4) and at least a section of the upper side (8) thereof.
